(19) United States
(12) Patent Application Publication
(10) Pub. No.: US 2012/0325358 A1
(43) Pub. Date: Dec. 27, 2012

(54) AIR DUCT

(75) Inventors: PO-LIN LIN, Tu-Cheng (TW); WEN-TANG PENG, Tu-Cheng (TW)

(73) Assignee: HON HAI PRECISION INDUSTRY CO., LTD., Tu-Cheng (TW)

(21) Appl. No.: 13/187,498

(22) Filed: Jul. 20, 2011

(30) Foreign Application Priority Data
Jun. 27, 2011 (TW) 100122513

(51) Int. Cl. F16L 55/00

(52) U.S. Cl. 138/103

(57) ABSTRACT

An air duct includes a main body and a panel. The main body includes a top wall defining a depressed portion. A front wall of the depressed portion defines an inlet. A rear wall of the depressed portion defines two outlets. The top wall forms two fixing portions at the front side of the top wall. A pole is mounted to the rear side of the top wall, between the outlets. A first end of the panel is rotatably connected to the pole; a second end of the board opposite to the first end is operable to be selectively mounted to one of the fixing portions.

### BACKGROUND

1. Technical Field

The present disclosure relates to an air duct.

2. Description of Related Art

In electronics, air ducts may be used to assist in dissipating heat generated by elements mounted on circuit boards. Usually, an element is mounted at or near an outlet of the air duct. As a result, if the element needs to be relocated to a different position, a new air duct may be needed as the old one may not be configured to be mounted in the new location.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an air duct; wherein the air duct includes a panel.

FIG. 2 is an assembled, isometric view of FIG. 1, showing a state of use.

FIG. 3 is another assembled, isometric view of FIG. 1, but showing another state of use.

FIG. 4 is an enlarged view of the panel of FIG. 1, but viewed from another perspective.

FIG. 5 is an assembled, isometric view of another exemplary embodiment of an air duct.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

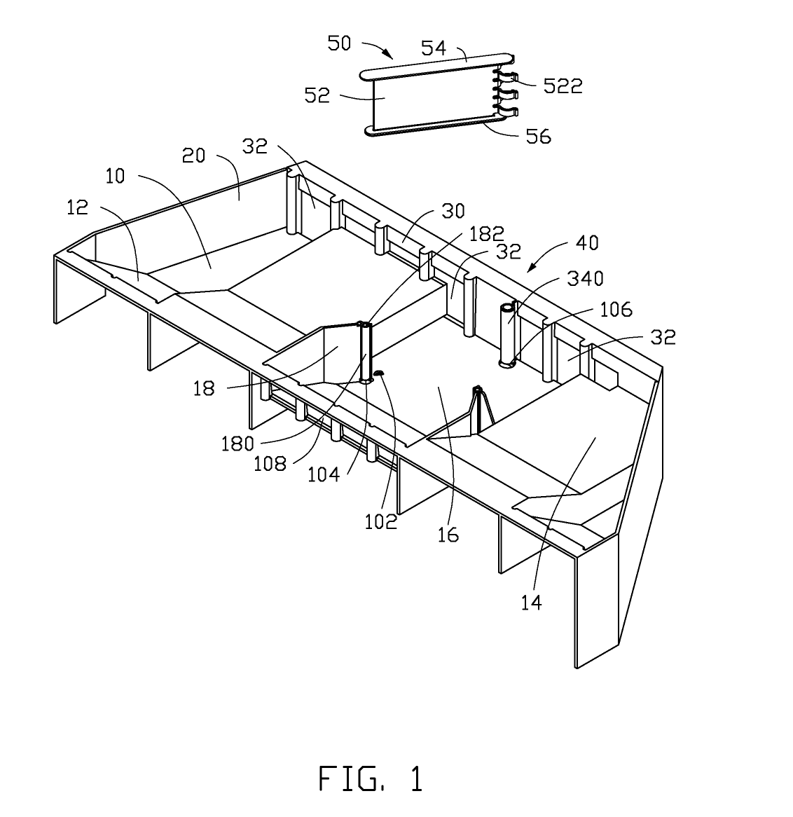

Referring to FIG. 1, an exemplary embodiment of an air duct includes a main body 40 and a panel 50.

The main body 40 includes a substantially trapezoidal top wall 10, two end walls 20 extending in a substantially perpendicular manner from opposite ends of the top wall 10, and a rear wall 30 extending up in a substantially perpendicular manner from a short side of the top wall 10. A slanted portion 12 is formed on the top wall 10 adjacent to the long side and slantingly declines towards the short side.

A space 14 is bounded by the top wall 10, the end walls 20 and the rear wall 30, above the top wall 10. A depressed portion 16 is defined in a top surface o of the top wall 10. An inlet 108 communicating with the depressed portion 16 is defined in the long side of the main body 40. Two substantially V-shaped fixing portions 18 extend into the depressed portion 14 from opposites sides bounding the depressed portion 16 adjacent to the slanted portion 12. A first pole 180 perpendicular to the top wall 10 is formed on a distal end of each fixing portion 18 opposite to the slanted portion 12. An engaging slot 104 is bounded by a bottom of the first pole 180 and the top wall 10. A fixing hole 182 is defined in a top of each first pole 180. A protrusion 102 protrudes up from the top wall 102 in the depressed portion 14, adjacent to a side of each first pole 180.

The rear wall 30 defines two outlets 32 communicating with the depressed portion 16 and facing the corresponding fixing portions 18. A second pole 340 perpendicular to the top wall 10 protrudes from the rear wall 30 in the depressed portion 16. An engaging slot 106 is bounded by a bottom of the second pole 340 and the top wall 10.

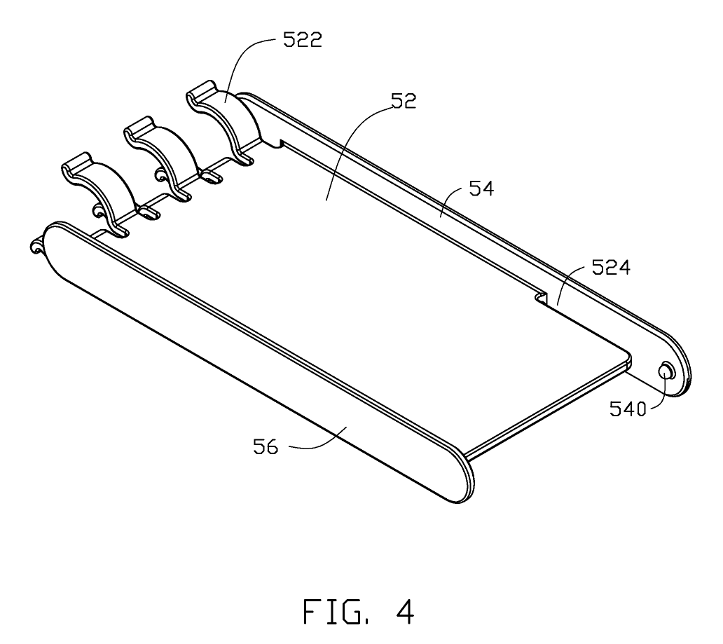

Referring to FIG. 4, the panel 50 includes a board 52, and a first bar 54 and a second bar 56 extending from opposite sides of the board 52, respectively. A plurality of arc-shaped clamping portions 522 extend from a first end of the board 52, along an extension direction of the first end. Every two adjacent clamping portions 522 are arced from each other, to form a substantially Y-shaped member. A projection 540 protrudes from an inner surface of a second end of the first bar 54 opposite to the first end. A slot 524 is defined between the board 52 and the first bar 54 adjacent to the projection 540. Thereby, the second end of the first bar 54 is deformable.

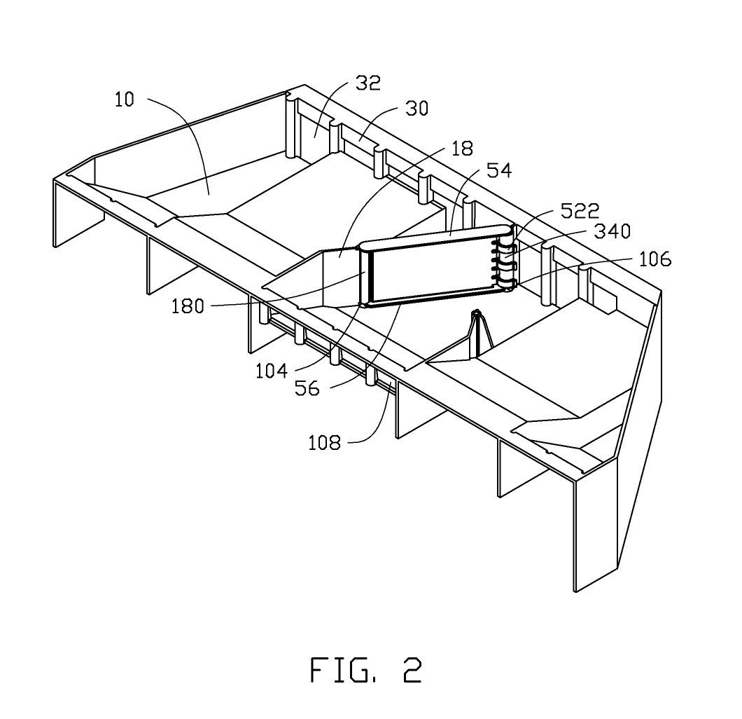

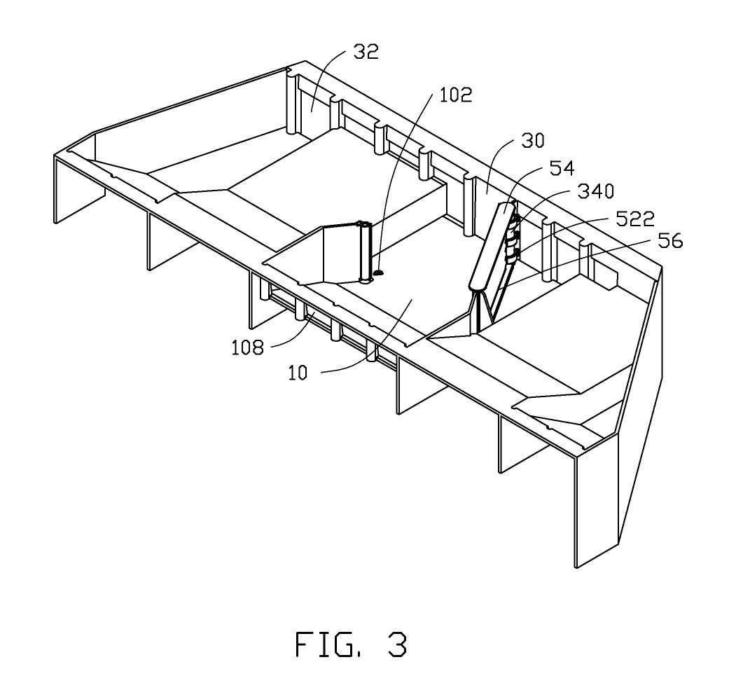

Referring to FIGS. 2 and 3, in assembly, the clamping portions 522 pivotably grasp the second pole 340. The first end of the second bar 56 is inserted into the engaging slot 106, the first end of the first bar 54 resists against a top of the second pole 340. Therefore, the first end of the panel 50 is pivotably mounted to the second pole 340. The panel 50 is rotated toward one of the fixing portions 18, until the second end of the second bar 56 engages in the corresponding engaging slot 104. The second end of the first bar 54 is deformed away from the second bar 56, and the projection 540 is in aligned with the fixing hole 182. The second end of the first bar 54 is restored, thereby the projection 540 engages in the fixing hole 182. The second end of the panel 50 is fixed to the fixing portion 18. The main body 50 is blocked by the protrusion 102. Airflow from the inlet 108 is guided by the panel 50 to the corresponding outlet 32 facing the other fixing portions 18.

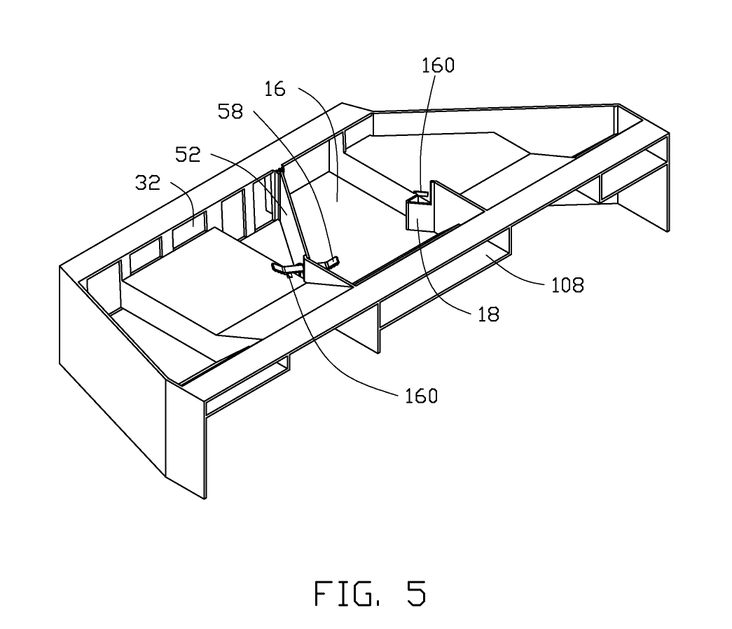

Referring to FIG. 5, in another embodiment, the first poles 180, and the first and second bars 54 and 56 of the panel 50 may be omitted, and instead the main body 52 configured long enough to be blocked by one of the fixing portions 18. A blocking portion 160 protrudes up from a top of the top wall 10 adjacent to the corresponding fixing portion 18. Two latches 58 extend away from each other from the second end of the main body 52. The latches 58 are latched to the corresponding blocking portions 160. The main body 52 is blocked by the corresponding fixing portions 18.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiments.

What is claimed is:

1. An air duct, comprising:
a main body comprising a top wall, the top wall defining a depressed portion, a front wall of the depressed portion defining an inlet, a rear wall of the depressed portion defining two outlets, the rear wall forming a first pole between the outlets, wherein two fixing portions extend from opposite sidewalls of the depressed portion into the depressed portion at the front wall; and
a panel pivotably mounted to the first pole with a first end, a second end of the panel is operable to be selectively mounted to one of the fixing portions.

2. The air duct of claim 1, wherein the panel comprises a board, a plurality of clamping portions extends from the first end of the board to grasp the first pole.

3. The air duct of claim 2, wherein each clamping portion is substantially arc-shaped, every two adjacent clamping portions are arced away from each other.

4. The air duct of claim 2, wherein a second pole is formed from a distal end of each fixing portion opposite to the front wall of the depressed portion, the second pole defines a fixing hole in a top, the panel further comprises a first bar and a second bar extending from opposite sides of the board, a projection extends from an inner surface of the second end of the first bar to selectively engage in the fixing hole of one of the fixing portions.

5. The air duct of claim 4, wherein an engaging slot is formed by each second pole and the top wall to receive the second end of the second bar.

6. The air duct of claim 5, wherein a protrusion protrudes from the top wall adjacent to each second pole in the depressed portion to block one of opposite sides of the panel.

7. The air duct of claim 3, wherein two blocking portions are formed on the top wall adjacent to each fixing portion, two latches extend from the board to be latched to the corresponding blocking portions.
